(19) United States
(12) Patent Application Publication
(10) Pub. No.: US 2024/0330587 A1
(43) Pub. Date: Oct. 3, 2024

(54) CONTEXTUALIZED SPELL CHECKER

(71) Applicant: Zoom Video Communications, Inc., San Jose, CA (US)

(72) Inventor: Aleksandra Swerdlow, Santa Clara, CA (US)

(73) Assignee: Zoom Video Communications, Inc., San Jose, CA (US)

(21) Appl. No.: 18/127,430

(22) Filed: Mar. 28, 2023

(51) Int. Cl. G06F 40/253; G06F 40/237

(52) U.S. Cl. CPC G06F 40/253; G06F 40/237

(57) ABSTRACT

In some implementations, techniques disclosed herein may include receiving, from a chat session by a video conference provider, text from a first client device associated with a first user. In addition, the techniques may include segmenting the text into one or more words. The techniques may include identifying one or more preliminarily misspelled words based on a first lexicon. Moreover, the techniques may include determining, for at least one of the one or more preliminarily misspelled words, whether the respective preliminarily misspelled word is correctly spelled based on a second lexicon. Also, the techniques may include responsive to determining the preliminarily misspelled word is correctly spelled, identifying the preliminarily misspelled word as correctly spelled.

### FIELD

The present application generally relates to video conferences and more specifically relates to spell checking using data from video conferences.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIGS. 1-4 show example systems for contextualized spell-checking;

FIG. 5 shows an example machine learning model for contextualized spell-checking;

FIG. 6 shows example graphical user interfaces (“GUIs”) for contextualized spell-checking;

FIG. 7 illustrates an example chat channel, according to an embodiment herein;

FIG. 8 shows an example method for providing contextualized spell checking; and

FIG. 9 shows an example computing device suitable for use with example systems and methods for providing contextualized spell-checking.

### DETAILED DESCRIPTION

Examples are described herein in the context of contextualized spell-checking using video conference data. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

A video conference provider may facilitate remote communication so that participants (e.g., users) may engage with each other to discuss any matters of interest. Typically, such participants will interact during a video conference using a camera and microphone, which provides video and audio streams (each a “media” stream) that can be delivered to the other participants by the video conference provider and be displayed via the various client devices' displays or speakers. However, video conference participants also engage in text-based communications before, during, and after the video conference. For instance, the communication could include a meeting invitation, a chat log during the conference, and follow up emails after the conference has concluded. In addition, text-based communication may occur in other contexts besides video conferences. For example, the video conference provider could host a chat channel that allows users to exchange text messages.

Typically spell-checking is offered for such text-based communications, but conventional spell-checking services can be deficient in evaluating contextual terms that have a meaning within a particular environment but are not part of a general lexicon. Such conventional spell-checking services may unnecessarily flag contextual terms, such as slang, jargon, and business terms (e.g., department names, project names, product names, and the like), as misspelled. In addition, contextual words can include proper names with nonstandard spellings that conventional spell-checking services often unnecessarily flag as misspelled. Thus, conventional spell-checking services suffer from deficiencies when evaluating contextual terms that are not part of a general lexicon (e.g., the standard body of words for a language).

To implement a spell-checking service that can properly classify contextual words, a video conference provider may use video conference metadata to generate a contextual lexicon for a particular video conference participant. The contextualized lexicon can then be used by a contextualized spell-checking process to classify words as properly spelled or misspelled. Classifying a word as misspelled may include identifying a word in either lexicon that most nearly matches the word.

A spell-checking process can use a general lexicon to classify words as correct or misspelled by comparing an input word against the words in the lexicon (e.g., lexicon entries). An input word can be classified as properly spelled (e.g., correct) if there is a match between the input word and a lexicon entry. Alternatively, the spell-checking service may flag a word as misspelled if the input word does not match a lexicon entry. Such conventional spell-checking services may classify properly spelled contextual terms as misspelled because they are not part of a standard lexicon for the language. Traditionally, this problem has been addressed by allowing a spell-checking service's users to add words to a lexicon. However, this process is time consuming, and a user can only add words to the lexicon if the user is already aware of the proper spelling.

Selectively adding words to a lexicon can be challenging for a video conference participant. Video conference participants may rely on the spell-checking service for the proper spelling of various words and the utility of a conventional spell-checking service is diminished if the participant is expected to provide the proper spellings. This problem is exacerbated when the user is encountering unfamiliar words such as the proper spelling of an acquaintance's name or the internal jargon at a new job. Ideally, a spell-checking service can correct the spelling of various words without relying on the user to provide the spell-checking service's ground truth.

To address these issues, a video conference provider can supplement the standard lexicon with a contextual lexicon generated for each video conference participant. A contextual lexicon can include words collected from video conference metadata associated with a particular user identifier. For instance, the contextual lexicon for a user identifier can include the names of conference participants, usernames for conference participants, video conference names, and breakout room names from video conferences where the user identifier was listed as an attendee or invitee. This contextual lexicon can include words derived from all video conferences that the user identifier is associated with, or the lexicon can include words derived from a subset of the conferences (e.g., all conferences during the last 6 months, all conferences during normal business hours, and the like).

In addition, a particular user identifier's contextual lexicon can include words associated with an organization or group. In some circumstances, the video conference provider may list the user identifier as a member of a particular organization such as a business or social group (e.g., the user identifier is part of a corporate account with the video conference provider). In such circumstances, the video conference provider may use metadata about that organization to supplement the particular user identifier's contextual lexicon (e.g., by adding names for each user in the corporate account).

Further, the video conference provider may use a social graph to add words to a particular user's contextual lexicon. A social graph is a model that uses graph theory to represent the interconnection of relationships in a social network. The social graph may be generated by the video conference provider, or the social graph can be generated by a third party such as a social media company, an email service, an instant messaging service, and the like. The video conference provider can use the social graph to identify one or more user accounts that have a relationship with a particular user account. These relationships can be direct (e.g., the related account is in the “friends list” for the particular account) or the relationship can be indirect (e.g., the related account and the particular account have a mutual friend). The lexicons for these related accounts can be cross referenced to identify words shared across multiple contextual lexicons (e.g., jargon that a threshold number of users have added to their contextual lexicons) and these shared words can be added to the particular user's contextual lexicon.

The contextual lexicon can be used by the video conference provider to supplement a conventional spell-checker as part of a contextual spell-checking service. A language detection process can analyze an input string to detect a language for the string. The input string can be provided to a text segmentation process that identifies and separates the input string's individual words. Upon or after the input string is segmented, a provisional spell-checking process can select an appropriate general lexicon, based on the detected language, and preliminarily classify the segmented words. Words in the input string that match an entry in the general lexicon are classified as correct (e.g., unlabeled) while words that do not match the general lexicon are labeled as misspelled (labeled with a “misspelled” flag). Words that are labeled as misspelled may also be labeled with one or more words from the lexicon that most nearly match the misspelled word.

The string with provisional labels output from the provisional spell-checking process can be provided as input to a contextual spell-checking process. This contextual spell-checking process can compare the preliminarily misspelled words (e.g., words in the string with a “misspelled” label) against entries in the contextual lexicon to determine whether the words are correctly spelled in this context. If the contextual spell-checking process finds that a word with a “misspelled” label matches the contextual lexicon, the contextual spell-checking process will remove the label from the word and output the string as spell-checked text. If a word labeled with “misspelled” does not match any words in the contextual lexicon, the contextual spell-checking process may label the misspelled word with one or more words from the lexicon that most nearly match the misspelled word.

In an illustrative example, the phrase “Madelyn went to the store tofay” is provided as part of a message during a video conference. Accordingly, the phrase is used as an input string to the video conference provider's language detection process. The process classifies the string as containing English and the string is segmented into its individual words. The segmented string is then provided to the preliminary spell-checking process which outputs the following string “Madelyn[misspelled:Madeline] went to the doctor tofay [misspelled:today]” where “Madelyn” and “tofay” are classified as misspelled. The string also includes the label “Madeline” as the nearest match in the general lexicon to “Madelyn” and “today” as the nearest match to “tofay.”

After leaving the provisional spell-checking process, the string is input to a contextual spell-checking process that checks the string's misspelled words against a contextual lexicon. In this case, the contextual lexicon does not contain a match for “tofay” which remains labeled as misspelled. In addition, today remains the nearest match to “tofay” because no words in the contextual lexicon is a closer match. However, Madelyn matches an entry in the contextual lexicon because a meeting participant that missed the meeting has that name. Accordingly, the label for Madelyn is removed and the following string is output as the spell-checked text “Madelyn went to the doctor tofay [misspelled:today].”

Contextualized spell checking can improve the productivity for employees or teams that use industry specific terminology (or “jargon”) such as a hospital billing department, an engineering team, a law firm, and the like. The spell-checking functionality can allow users of a chat channel, email service or video conferencing service to communicate effectively by verifying and correcting the spelling. In particular, this functionality is beneficial for new members of a team who may not know the specific spelling for particular terms or the spelling for team member names. Without this functionality, new team members may spend time verifying the spelling of unfamiliar words rather than focusing on substantive tasks. In addition, new team members may feel like an outsider when other team members misspell their name. Accordingly, contextualized spell-checking functionality can allow for team members with unconventionally spelled names to feel included in the team by providing the team with the proper spelling of each team member's name.

This illustrative example is given to introduce the reader to the general subject matter discussed herein and the disclosure is not limited to this example. The following sections describe various additional non-limiting examples and examples of providing real-time translation during video conferences

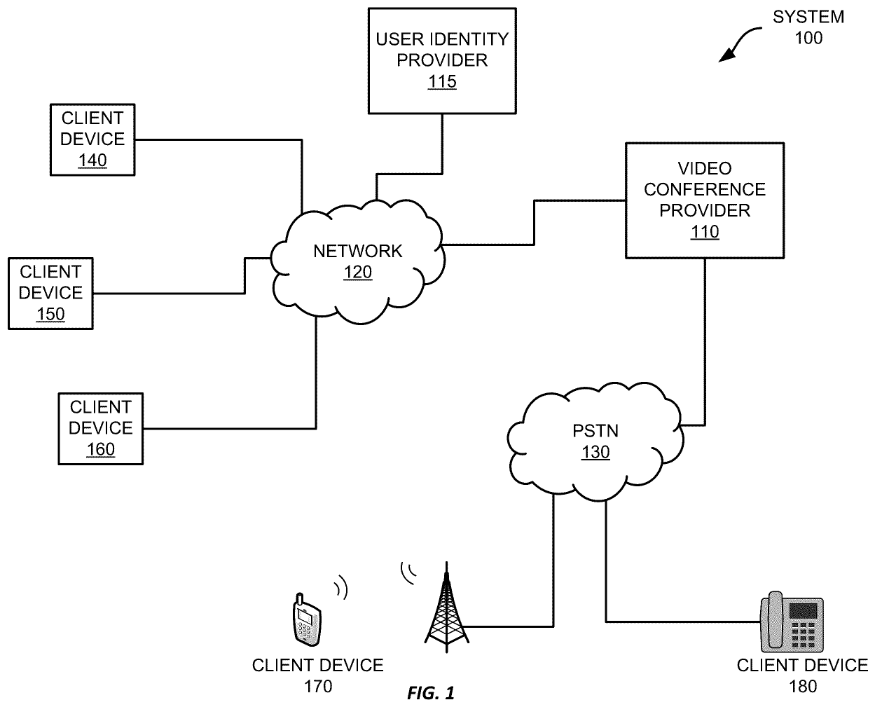

Referring now to FIG. 1, FIG. 1 shows an example system 100 that provides videoconferencing functionality to various client devices. The system 100 includes a video conference provider 110 that is connected to multiple communication networks 120, 130, through which various client devices 140-180 can participate in video conferences hosted by the video conference provider 110. For example, the video conference provider 110 can be located within a private network to provide video conferencing services to devices within the private network, or it can be connected to a public network, e.g., the internet, so it may be accessed by anyone. Some examples may even provide a hybrid model in which a video conference provider 110 may supply components to enable a private organization to host private internal video conferences or to connect its system to the video conference provider 110 over a public network.

The system optionally also includes one or more user identity providers, e.g., user identity provider 115, which can provide user identity services to users of the client devices 140-160 and may authenticate user identities of one or more users to the video conference provider 110. In this example, the user identity provider 115 is operated by a different entity than the video conference provider 110, though in some examples, they may be the same entity. In some instances, video conference provider 110 may provide a user profile language to video conference provider 210.

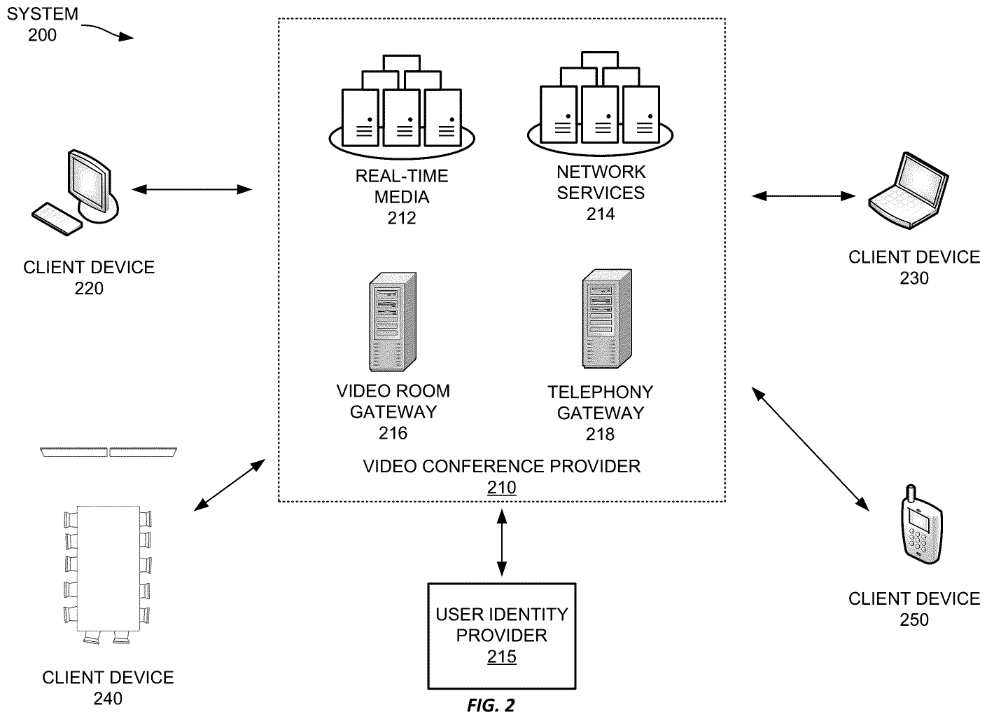

Video conference provider 110 allows clients to create videoconference meetings (or “meetings”) and invite others to participate in those meetings as well as perform other related functionality, such as recording the meetings, generating transcripts from meeting audio, manage user functionality in the meetings, enable text messaging during the meetings, create and manage breakout rooms from the main meeting, etc. FIG. 2, described below, provides a more detailed description of the architecture and functionality of the video conference provider 110.

Meetings in this example video conference provider 110 are provided in virtual “rooms” to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used. Further, in some examples, and as alluded to above, a meeting may also have “breakout” rooms. Such breakout rooms may also be rooms that are associated with a “main” videoconference room. Thus, participants in the main videoconference room may exit the room into a breakout room, e.g., to discuss a particular topic, before returning to the main room. The breakout rooms in this example are discrete meetings that are associated with the meeting in the main room. However, to join a breakout room, a participant must first enter the main room. A room may have any number of associated breakout rooms according to various examples.

To create a meeting with the video conference provider 110, a user may contact the video conference provider 110 using a client device 140-180 and select an option to create a new meeting. Such an option may be provided in a webpage accessed by a client device 140-160 or client application executed by a client device 140-160. For telephony devices, the user may be presented with an audio menu that they may navigate by pressing numeric buttons on their telephony device. To create the meeting, the video conference provider 110 may prompt the user for certain information, such as a date, time, and duration for the meeting, a number of participants, a type of encryption to use, whether the meeting is confidential or open to the public, a meeting language, etc. After receiving the various meeting settings, the video conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The video conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating that the meeting has not yet started or the host may be required to specifically admit one or more of the users.

During the meeting, the participants may employ their client devices 140-180 to capture audio or video information and stream that information to the video conference provider 110. They also receive audio or video information from the video conference provider 210, which is displayed by the respective client device 140 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting and they will no longer receive audio or video streams for the meeting (and will stop transmitting audio or video streams). The video conference provider 110 may also invalidate the meeting information, such as the meeting identifier or password/passcode. The video conference provider 110 may record the meeting identifier, a user identifier for each meeting participant, a transcript, a text log, a list of email addresses that were used to send the meeting invite, and other information as meeting metadata.

To provide such functionality, one or more client devices 140-180 may communicate with the video conference provider 110 using one or more communication networks, such as network 120 or the public switched telephone network (“PSTN”) 130. The client devices 140-180 may be any suitable computing or communications device that have audio or video capability. For example, client devices 140-160 may be conventional computing devices, such as desktop or laptop computers having processors and computer-readable media, connected to the video conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a video conference meeting hosted by the video conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the video conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can make conventional telephone calls and is not limited solely to dedicated telephony devices like conventional telephones.

Referring again to client devices 140-160, these devices 140-160 contact the video conference provider 110 using network 120 and may provide information to the video conference provider 110 to access functionality provided by the video conference provider 110, such as access to create new meetings or join existing meetings. To do so, the client devices 140-160 may provide user identification information, meeting identifiers, meeting passwords or passcodes, etc. In examples that employ a user identity provider 115, a client device, e.g., client devices 140-160, may operate in conjunction with a user identity provider 115 to provide user identification information or other user information to the video conference provider 110.

A user identity provider 115 may be any entity trusted by the video conference provider 110 that can help identify a user to the video conference provider 110. For example, a trusted entity may be a server operated by a business or other organization and with whom the user has established their identity, such as an employer or trusted third-party. The user may sign into the user identity provider 115, such as by providing a username and password, to access their identity at the user identity provider 115. The identity, in this sense, is information established and maintained at the user identity provider 115 that can be used to identify a particular user, irrespective of the client device they may be using. An example of an identity may be an email account established at the user identity provider 110 by the user and secured by a password or additional security features, such as biometric authentication, two-factor authentication, etc. However, identities may be distinct from functionality such as email. For example, a health care provider may establish identities for its patients. And while such identities may have associated email accounts, the identity is distinct from those email accounts. Thus, a user's “identity” relates to a secure, verified set of information that is tied to a particular user and should be accessible only by that user. By accessing the identity, the associated user may then verify themselves to other computing devices or services, such as the video conference provider 110.

When the user accesses the video conference provider 110 using a client device, the video conference provider 110 communicates with the user identity provider 115 using information provided by the user to verify the user's identity. For example, the user may provide a username or cryptographic signature associated with a user identity provider 115. The user identity provider 115 then either confirms the user's identity or denies the request. Based on this response, the video conference provider 110 either provides or denies access to its services, respectively. The user identify provider 115 may provide a user profile language to the video conference provider 110.

For telephony devices, e.g., client devices 170-180, the user may place a telephone call to the video conference provider 110 to access video conference services. After the call is answered, the user may provide information regarding a video conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the video conference provider 110. For example, telephony devices may be unable to provide user identification information to identify the telephony device or the user to the video conference provider 110. Thus, the video conference provider 110 may provide more limited functionality to such telephony devices. For example, the user may be permitted to join a meeting after providing meeting information, e.g., a meeting identifier and passcode, but they may be identified only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting. The telephone numbers for such telephony devices may be recorded as meeting metadata.

It should be appreciated that users may choose to participate in meetings anonymously and decline to provide user identification information to the video conference provider 110, even in cases where the user has an authenticated identity and employs a client device capable of identifying the user to the video conference provider 110. The video conference provider 110 may determine whether to allow such anonymous users to use services provided by the video conference provider 110. Anonymous users, regardless of the reason for anonymity, may be restricted as discussed above with respect to users employing telephony devices, and in some cases may be prevented from accessing certain meetings or other services, or may be entirely prevented from accessing the video conference provider 110.

Referring again to video conference provider 110, in some examples, it may allow client devices 140-160 to encrypt their respective video and audio streams to help improve privacy in their meetings. Encryption may be provided between the client devices 140-160 and the video conference provider 110 or it may be provided in an end-to-end configuration where multimedia streams transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the video conference provider 110, while allowing the video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

By using the example system shown in FIG. 1, users can create and participate in meetings using their respective client devices 140-180 via the video conference provider 110. Further, such a system enables users to use a wide variety of different client devices 140-180 from traditional standards-based video conferencing hardware to dedicated video conferencing equipment to laptop or desktop computers to handheld devices to legacy telephony devices, etc. Identifying information for the client devices 140-180 can be recorded by the video conference provider as meeting metadata.

Referring now to FIG. 2, FIG. 2 shows an example system 200 in which a video conference provider 210 provides spell-checking and videoconferencing functionality to various client devices 220-250. The client devices 220-250 include two conventional computing devices 220-230, dedicated equipment for a video conference room 240, and a telephony device 250. Each client device 220-250 communicates with the video conference provider 210 over a communications network, such as the internet for client devices 220-240 or the PSTN for client device 250, generally as described above with respect to FIG. 1. The video conference provider 210 is also in communication with one or more user identity providers 215, which can authenticate various users to the video conference provider 210 generally as described above with respect to FIG. 1. The user identity providers 215 can be third-party organizations that can provide access to a social graph in addition to authentication services. For instance, the user identity providers can be social media organizations, email providers, instant messaging services, or any other organization that tracks interactions between its users.

In this example, the video conference provider 210 employs multiple different servers (or groups of servers) to provide different aspects of video conference functionality, thereby enabling the various client devices to create and participate in video conference meetings. The video conference provider 210 uses one or more real-time media servers 212, one or more network services servers 214, one or more video room gateways 216, and one or more telephony gateways 218. Each of these servers 212-218 is connected to one or more communications networks to enable them to collectively provide access to and participation in one or more video conference meetings to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the video conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing. In some instances, the media stream may contain metadata indicating a language for the media stream or the client devices 220-250. The language may be a device language provided by software on the client device or a language selected by a user of the client device via a graphical user interface (GUI).

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed streams to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O) as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220's own video and audio feeds when transmitting streams to it. Instead each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the video conference provider 210. In some such examples, the real-time media servers 212 may decrypt incoming multimedia streams, multiplex the multimedia streams appropriately for the various clients, and encrypt the multiplexed streams for transmission.

In some examples, to provide multiplexed streams, the video conference provider 210 may receive multimedia streams from the various participants and publish those streams to the various participants to subscribe to and receive. Thus, the video conference provider 210 notifies a client device, e.g., client device 220, about various multimedia streams available from the other client devices 230-250, and the client device 220 can select which multimedia stream(s) to subscribe to and receive. In some examples, the video conference provider 210 may provide to each client device the available streams from the other client devices, but from the respective client device itself, though in other examples it may provide all available streams to all available client devices. Using such a multiplexing technique, the video conference provider 210 may enable multiple different streams of varying quality, thereby allowing client devices to change streams in real-time as needed, e.g., based on network bandwidth, latency, etc.

As mentioned above with respect to FIG. 1, the video conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the video conference provider 210 may allow a meeting participant to notify it of inappropriate behavior or content in a meeting. Such a notification may trigger the real-time media servers to 212 record a portion of the meeting for review by the video conference provider 210. Still other functionality may be implemented to take actions based on the decrypted multimedia streams at the video conference provider, such as monitoring video or audio quality, adjusting or changing media encoding mechanisms, recording metadata, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the video conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the video conference provider 210 and across many different real-time media servers 212.

Turning to the network services servers 214, these servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the video conference provider under a supervisory set of servers. When a client device 220-250 accesses the video conference provider 210, it will typically communicate with one or more network services servers 214 to access their account or to participate in a meeting.

When a client device 220-250 first contacts the video conference provider 210 in this example, it is routed to a network services server 214. The client device may then provide access credentials for a user, e.g., a username and password or single sign-on credentials, to gain authenticated access to the video conference provider 210. This process may involve the network services servers 214 contacting a user identity provider 215 to verify the provided credentials. Once the user's credentials have been accepted, the client device 220-250 may perform administrative functionality, like updating user account information, if the user has an identity with the video conference provider 210, or scheduling a new meeting, by interacting with the network services servers 214.

In some examples, users may access the video conference provider 210 anonymously. When communicating anonymously, a client device 220-250 may communicate with one or more network services servers 214 but only provide information to create or join a meeting, depending on what features the video conference provider allows for anonymous users. For example, an anonymous user may access the video conference provider using client 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, a meeting language, a source language or a target language for translation, etc. The network services servers 214 may then create and store a meeting record for the scheduled meeting. When the scheduled meeting time arrives (or within a threshold period of time in advance), the network services server(s) 214 may accept requests to join the meeting from various users.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams. In some instances, the real-time media servers 212 may store a source language, target language, user profile language, meeting language, or identified language for the multimedia streams sent and received by the server.

Once the host has started the meeting, subsequent users requesting access will be admitted to the meeting if the meeting record is located and the passcode matches the passcode supplied by the requesting client device 220-250. In some examples additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another user as the new meeting host and assign host administrative privileges to that user. Hosts may have administrative privileges to allow them to manage their meetings, such as by enabling or disabling screen sharing, muting or removing users from the meeting, creating sub-meetings or “break-out” rooms, recording meetings, etc. Such functionality may be managed by the network services server(s) 214.

For example, if a host wishes to remove a user from a meeting, they may identify the user and issue a command through a user interface on their client device. The command may be sent to a network services server 214, which may then disconnect the identified user from the corresponding real-time media server 212. If the host wishes to create a break-out room for one or more meeting participants to join, such a command may also be handled by a network services server 214, which may create a new meeting record corresponding to the break-out room and then connect one or more meeting participants to the break-out room similarly to how it originally admitted the participants to the meeting itself.

In addition to creating and administering on-going meetings, the network services server(s) 214 may also be responsible for closing and tearing-down meetings once they have completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request.

Depending on the functionality provided by the video conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the video conference provider 210. For example, the video conferencing hardware may be provided by the video conference provider to one or more of its subscribers, which may provide access credentials to the video conferencing hardware to use to connect to the video conference provider 210.

The video room gateway servers 216 provide specialized authentication and communication with the dedicated video conferencing hardware that may not be available to other client devices 220-230, 250. For example, the video conferencing hardware may register with the video conference provider 210 when it is first installed and the video room gateway servers 216 may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the video conference provider 210.

Referring now to the telephony gateway servers 218, these servers 218 enable and facilitate telephony devices' participation in meetings hosed by the video conference provider 210. Because telephony devices communicate using the PSTN and not using computer networking protocols, such as TCP/IP, the telephony gateway servers 218 act as an interface that converts between the PSTN and the networking system used by the video conference provider 210.

For example, if a user uses a telephony device to connect to a meeting, they may dial a phone number corresponding to one of the video conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio signals to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server 218 is instead joined to the meeting on the telephony device's behalf.

After joining the meeting, the telephony gateway server 218 receives an audio stream from the telephony device and provides it to the corresponding real-time media server 212, and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the video conference provider 210 discussed above are merely examples of such devices and an example architecture. Some video conference providers may provide more or less functionality than described above and may not separate functionality into different types of servers as discussed above. Instead, any suitable servers and network architectures may be used according to different examples.

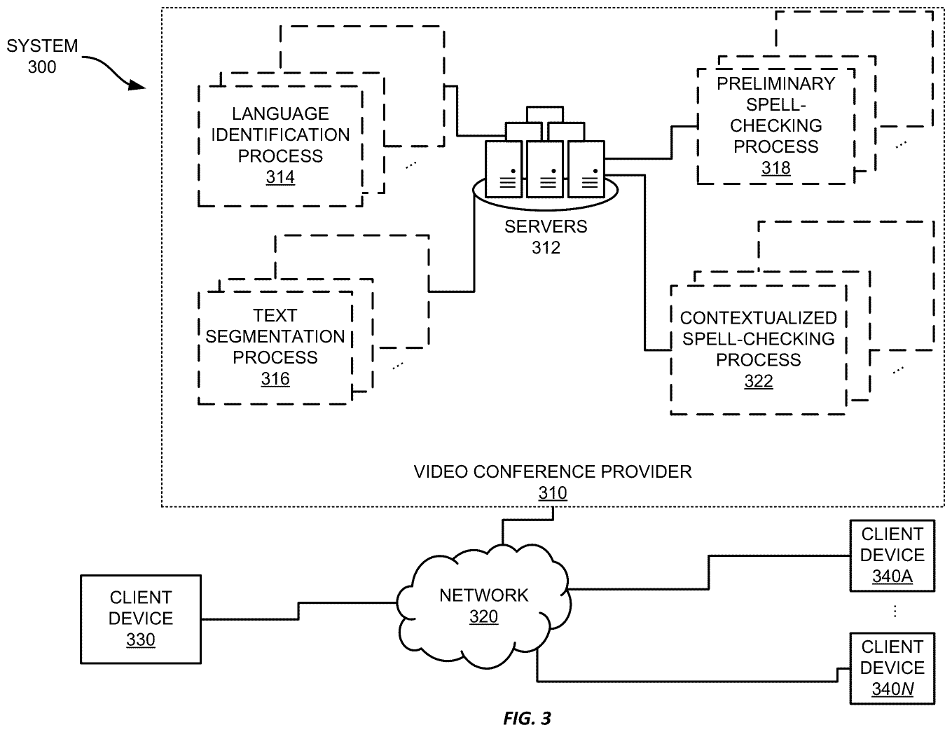

Referring now to FIG. 3, FIG. 3 shows an example system 300 for providing spell-checking functionality for text based communication facilitated by a video conference provider. The system 300 includes a video conference provider 310, which can be connected to multiple client device 330, 340a-n via one or more intervening communication networks 320. In this example, the communications network 320 is the internet, however, any suitable communications network or combination of communications network may be employed, including LANs (e.g., within a corporate private LAN), WANs, etc.

Each client device 330, 340a-n executes video conference software, which allows a user to connect to the video conference provider 310 to join meetings or interact with other functionality provided by the video conference provider, such as chat (e.g., text-based communication). During the meeting, the various participants (using video conference software or “client software” at their respective client devices 330, 340a-n) are able to interact with each other to conduct the meeting, such as by typing text messages, viewing video feeds and hearing audio feeds from other participants, and by capturing and transmitting video and audio of themselves.

The video conference provider 310 operates a number of servers 312 that can provide spell-checking functionality for text-based messages sent between the client devices 330,340a-n. Language identification functionality is provided by one or more language identification processes 314 that can be executed and allocated to text-based services hosted by the video conference provider 310. The text-based services can include instant messaging services, persistent chat channel services, email services, word processing services, search engine services, graphical user interfaces, web browsers, chatbots, and the like. Similarly, text segmentation functionality is provided by one or more text segmentation processes 316 that can be executed and allocated to text-based services hosted by the video conference provider 310. In addition, the preliminary spell-checking functionality is provided by one or more preliminary spell-checking processes 318 that can be executed an allocated to text-based services hosted by video conference provider 310. In addition, the contextual spell-checking functionality is provided by one or more contextual spell-checking processes 322 that can be executed an allocated to text-based services hosted by video conference provider 310.

Client device 330, 340a-n may interact using text-based communication services hosted by the video conference provider 310 before, during, and after a video conference. For instance, client device 330 may send a text-based instant message to client device 340a to inquire when a conference should be scheduled. After confirming the conference start time, client device can send an invitation, with a text-based message, to the intended conference participants via an email service hosted by the video conference provider 310. At the start time, the client devices 330, 340a-n can connect to the video conferences provider and joining a desired video conference, generally as discussed above with respect to FIGS. 1-2. Once the participants have joined the conference, they may interact with each other through a text-based instant messaging service, in addition to communicating by exchanging audio and video feeds. After the conference has concluded, the participants may communicate via a chat service or an email service hosted by the video conference provider 310.

Spell checking functionality may be enabled by default, or, to request spell-checking services, a participant may select an option within their client software to enable/disable spell-checking. The client software may detect that the client device is receiving text-based input to a graphical user interface. In response, the client software then sends a request to the video conference provider 310 for the selected spell-checking services.

After receiving a request for translation services, the video conference provider 310 allocates one or more language identification processes 314 for the client device. The language identification process can be a machine learning model that detects a language in a text string. The detected language is used to select a text segmentation process 316, a preliminary spell-checking process 318 or a contextualized spell-checking process 322, all of which may be language dependent. For example, the text segmentation process 316 may employ a language dependent machine learning model to segment text strings into words. In addition, the preliminary spell-checking process 318 or the contextual spell-checking process 322 may use language dependent lexicons to classify words. In addition, the spell-checking processes 322 may use language dependent rules/machine learning models to transform input words into different morphological forms by adding, changing, or removing a word's prefixes or suffixes (e.g., transform “in-dependent-ly” to “dependent” or “re-submit” to “submit”). In some embodiments, a language identification process is not allocated for the client device and the language is selected based on a language associated with the operating system on the client device, a language associated with a user account/user identifier, a language for a virtual conference, and the like.

Similarly, the video conference provider 310 allocates one or more text segmentation processes 316, depending on the detected language. Each text segmentation process 316 can be configured to identify individual words in a text string. The text segmentation process 316 may be configured to identify words in multiple source languages or the segmentation processes may be configured to segment text strings containing text in a specific language. The segmentation process can use a rules-based approach to segment a text string into individual words (e.g., by using American Standard Code for Information Interchange (ASCII) codes to identify periods, spaces, or commas in the text and using these characters to identify word) or using a trained machine learning model to identify individual words.

The preliminary spell-checking processes 318 can receive the extracted words from the text segmentation process 316 and compare these words against a general lexicon to identify preliminarily misspelled words. A word can be labeled as preliminarily misspelled if the word, or a morphological transformation of the word, matches an entry in the lexicon (e.g., a word in the lexicon). The general lexicon can be a list of standard words for a language, and the words in the general lexicon can be obtained from a variety of sources such as one or more dictionaries. In addition, books, song lyrics, scientific papers, or websites can be used as sources for words in the general lexicon. The general lexicon can include definitions, synonyms, or antonyms for one or more of the lexicon's words, and, in some examples, a definition, synonym, or antonym can be presented on a client device in response to a user input (e.g., by right clicking on a word). The general lexicon may also include prefixes, suffixes that can be added to base words in the lexicon.

Upon or after this preliminary labeling, the video conference provider 310 can allocate one or more contextualized spell-checking processes 322 for the client device and the extracted words, with any preliminary labels, can be provided to the contextualized spell-checking process. The contextualized spell-checking process 322 can be software that compares the preliminarily misspelled words against a contextual lexicon to determine if the preliminarily misspelled words match a word in the contextual lexicon (e.g., match an entry in the contextual lexicon). A preliminarily misspelled word that matches an entry in the contextual lexicon can be labeled by the contextual spell-checking process as a misspelled word.

A contextual lexicon can be a list of words that are particular to a user account, a group of user accounts, a geographic region, a client device, or an organization. For example, a contextual lexicon for a user account in an organization can include the organization name, the organization's product names, the organization's department names, the titles of video conferences that the user account has been invited to, file paths shared in chats during these conferences, an employee directory from the organization, words added to the contextual lexicon by the user account, and words in the contextual lexicons of similar users accounts.

This list of words may be added to the contextual lexicon from one or more sources and at various times. A user can manually add words to the contextual lexicon using a graphical user interface on a client device 330, 340a-n (e.g., by highlighting a word and selecting “add to dictionary” from a menu). Proper names, street addresses, email addresses, or phone numbers can be added to the contextual lexicon from a directory database for an organization. The directory can be polled at regular intervals and entries to the lexicon can be added, or removed, based on whether the entries are present in the directory.

In addition, words can be added to a contextual lexicon based on the words in, or added to, the contextual lexicons of other related users. For instance, a word can be added to user's a contextual lexicon if that word is added to the contextual lexicon for a member of that user's team. A social graph can be used to identify related users and a word can be added to a particular user's contextual lexicon if the word is an entry in a sufficiently related user's lexicon (e.g., if the probability that the two users are related is above a threshold). The word may be added as an entry if the word is present in the lexicons of a threshold number of related users.

In some embodiments, a user may be able to share lexicon entries in message metadata sent between client devices 330, 340a-n. For example, if a first user uses a word in their contextual lexicon during communication with a second user, the used word's proper spelling may be included as metadata for the communication so that the word may be added as an entry to the second user's contextual lexicon or used by the second user's spell checker for the duration of the meeting. The word may be automatically added as an entry to the lexicon or the user receiving the communication can be prompted, such as on a graphical user interface, to approve adding the word to their contextual lexicon. This addition can help the proper spelling of a word travel with its usage so that new words can be dynamically added to spell checkers based on the word's use.

Two users' accounts can be similar, and contextual lexicon entries can be shared between the accounts, if the two accounts are sufficiently related in a social graph. A social graph can be a graph of nodes, representing users, connected by edges that represent relationships. Each edge can be generated from a piece of metadata from the video conference provider 310. For instance, two nodes may be related if they both share the same last name, if the two accounts attended the same virtual conference, if the two accounts share relationships with a third user account, if the two accounts share an email address, and the like. A trained machine learning model can navigate the social graph to calculate the probability that there is a relationship between a user account and another account in the graph. Two accounts can be related if the calculated probability is above a threshold.

The contextual lexicon can be used to determine context specific spellings. A spell-checked word may have the correct spelling for most circumstances, but the word can be misspelled in a specific context. Each spell-checked word can be compared, by the preliminary spell-checking process 318, to a general lexicon (e.g., containing the correct spellings for most circumstances) and a word that matches an entry can be labeled as “preliminarily correct.” A word that does not match a general lexicon entry can be designated as “preliminarily misspelled.” These preliminarily misspelled words can be compared, by the contextual spell-checking process 322, to a contextual lexicon to determine whether the preliminarily misspelled word has a contextual meaning (e.g., the word matches an entry in the contextual lexicon) or if the word is actually misspelled (e.g., the word does not match an entry in the contextual lexicon).

The preliminarily correct words may not be spell-checked by the contextual spell-checking process 322 because the words already match a general spelling. It is likely that the general spelling is correct in most circumstances and checking for a contextual meaning may lead to words being misclassified. However, some types of words may be more likely to have contextual meanings and, in some examples, preliminarily correct words (e.g., words that matched an entry in the general lexicon) can be compared against entries in the contextual lexicon to determine if there is a different contextual spelling for these words that otherwise appear, at first glance, to be correctly spelled.

For instance, contextual meanings may be more likely for named entities (e.g., individuals, concepts, objects, organizations, or places that have a proper name). Companies may use nonstandard spellings because words with such spellings may be easier to trademark. In addition, non-traditional spellings for individual names may be chosen as a form of self-expression. For example, a parent may want a unique name for their child, and, to this end, the parent may choose a nonstandard spelling for the child's name (e.g., “Jaxon” instead of “Jackson”).

The contextual spell-checking process 322 can use named entity recognition to filter preliminarily correct words so that only a subset of misspelled words, that are most likely to have a contextual spelling, are compared against the contextual lexicon. Named entity recognition is a classification task where words, or groups of words, are identified as named entities (e.g., words that refer to a predefined category such as person names, organizations, locations, medical codes, time expressions, quantities, monetary values, percentages, and the like). The contextual spell-checking process 322 can use a trained machine learning model to perform named entity recognition and identify a subset of preliminarily correct words that refer to named entities. Named entity recognition can be performed by a trained machine learning model in the contextual spell-checking process.

If the subset of preliminarily correct words contain a word that is similar to an entry in the contextual lexicon, the word may be classified as misspelled, or having an alternative spelling, by the contextual spell-checking process. A word can be similar to an entry in the contextual lexicon if the words share a threshold number of characters, or a threshold percentage, of characters in common. For example, the word “Alexis” may match “Lexi” or “Jose” may match “Jace” because all but two of the character in each example match (e.g., the same character is in the same position). In addition, a trained machine learning model may compare the preliminarily correct word against entries in the contextual lexicon and generate a probability that the words match. For example, “Alexis” may be classified as matching “Lexi” because the model determines that there is a greater than 90% chance that the words match, while the model may determine that “Jose” and “Jace” do not match because the model determines that there is a less than 90% change that the words match.

At the end of a text-based communication or at the conclusion of a time period, the video conference provider 310 de-allocates the allocated language identification, text segmentation, preliminary spell checking, and contextualized spell-checking processes 314, 316, 318, 322 from the text-based communication channel and returns them to the pool of available, but idle language identification, text segmentation, preliminary spell checking, and contextualized spell-checking processes 314, 316, 318, 322 making them available to be allocated to other text-based communication channels or for termination if the video conference provider 310 determines it has too many idle language identification, text segmentation, preliminary spell checking, and contextualized spell-checking processes 314, 316, 318, 322.

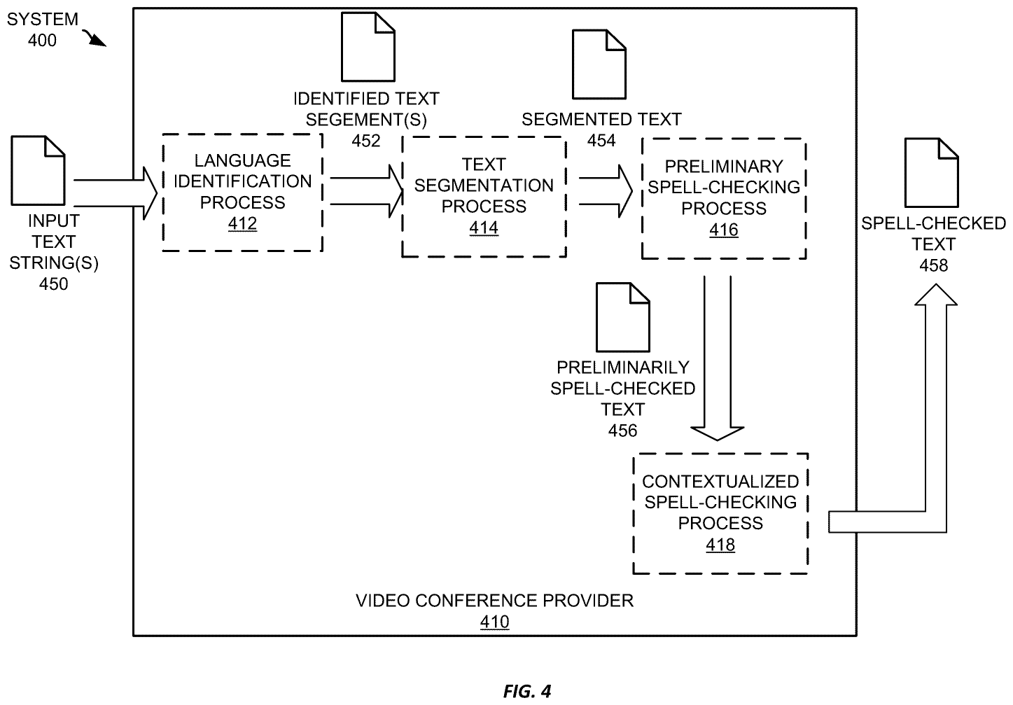

Referring now to FIG. 4, FIG. 4 shows an example data flow diagram for system that provides contextualized spell-checking. The system includes a video conference provider 410 that is hosting a video conference, or text-based communication, between multiple client devices, such as client device 330, 340a-n. The video conference provider 410 has received a request to spell-check an input string. The request can be generated in response to input text received at a graphical user interface operating on a client device. Before, during and after video conferences, the video conference provider 410 receives input text string(s) 452 from the various client devices and identifies an input language for the string(s), such as by receiving an identification of a participant within the translation request or by performing language identification on the received text string(s) 450. The language identification can be provided by a language identification process 412, and the identified text string(s) 452 (e.g., text string(s) labeled with a language) can be provided to the segmentation process 414. The language identification process 412 can use a trained machine learning model to identify (e.g., recognize) one or more languages.

The identified text segment(s) 452 can be provided to the text segmentation process 414, which generates segmented text 454 (e.g., one or more words) from the identified text segment(s) 452. The segmented text 454 are then provided to one or more allocated preliminary spell-checking processes 416. The spell-checking process 416 can compare the segmented text 454 against a general lexicon to identify one or more preliminarily misspelled words and one or more preliminarily correct words that are provided as preliminarily spell-checked text 456 to the contextualized spell-checking process 418. The contextualized spell-checking process can compare the preliminarily spell-checked text 456 against a contextualized lexicon to identify and label one or more misspelled words. The contextualized spell-checking process 418 can output the string, with the misspelled words labeled, as a spell-checked text 458. The spell-checked text can be used to annotate (e.g., underline, box, highlight, italicize or otherwise emphasize) any misspelled words in the input text on the graphical user interface.

While the example shown in FIG. 4 illustrates only a single language identification process 412, a single text segmentation process 414, a single preliminary spell-checking process 416, and a single contextualized spell-checking process 418, any number of such processes 412, 414, 416, 418 may operate simultaneously for a set time period or during a session of text-based communication. Further the video conference provider 410 may process multiple concurrent input text strings, each of which may be allocated one or more language identification, segmentation, preliminary spell-checking and contextual spell-checking processes 412, 414, 416, 418.

Various processes that are used by the video conference provider 210, 310, 410 to provide spell-checking functionality, such as language identification process 412, text segmentation process 414, preliminary spell-checking process 416, and contextualized spell-checking process 418, can be implemented, at least in part, using a machine learning model as described above. In addition, the social graph described above may be implemented with one or more machine learning models. The machine learning model can be a convolutional neural network that is trained on inputs with known labels (e.g., two user accounts with a known relationship, a text string with known segments, a text segment with a known language, two matching words, text strings with labeled named entities, and the like). After training, the machine learning model can receive an input with an unknown label and the model may output a probability, or confidence score, that the input should be classified with a particular label. In some examples, the processes may be implemented using more than one machine learning model.

For example, to train machine learning model to detect a language, text strings from a known language (e.g., training data) can be provided as input to the machine learning model. The machine learning model can output a classification (e.g., confidence score) for the input text strings, and, during training, the model parameters can be modified until the output classification for the input text string matches the known language for that string. For a neural network, the model parameters can be the total number of nodes, the number of nodes in a layer, the number of layers, and the weights for connections between nodes. Once the model properly classifies the training data, the model can be tested on verification data. The verification data can be text strings, from a known language, that were not used earlier in the training process. If the machine learning model correctly classifies the verification data, the machine learning model can be a trained machine learning model.

Examples of machine learning models include deep learning models, neural networks (e.g., deep learning neural networks), kernel-based regressions, adaptive basis regression or classification, Bayesian methods, ensemble methods, logistic regression and extensions, Gaussian processes, support vector machines (SVMs), a probabilistic model, and a probabilistic graphical model. Embodiments using neural networks can employ using wide and tensorized deep architectures, convolutional layers, dropout, various neural activations, and regularization steps.

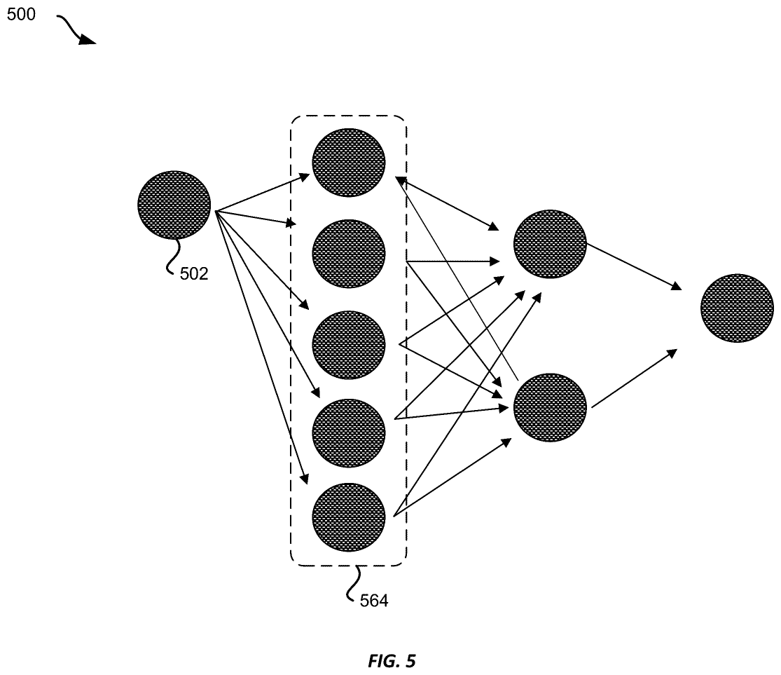

Referring now to FIG. 5, FIG. 5 shows an example machine learning model of a neural network. As an example, the language identification process can provide language identification functionality using a neural network that comprises a number of neurons (e.g., neuron 502; Adaptive basis functions) organized in layers (e.g., layer 504). The training of the neural network can iteratively search for the best configuration of the parameters of the neural network for feature recognition and classification performance. Various numbers of layers and nodes may be used. A person with skill in the art can recognize variations in a neural network design and design of other machine learning models.

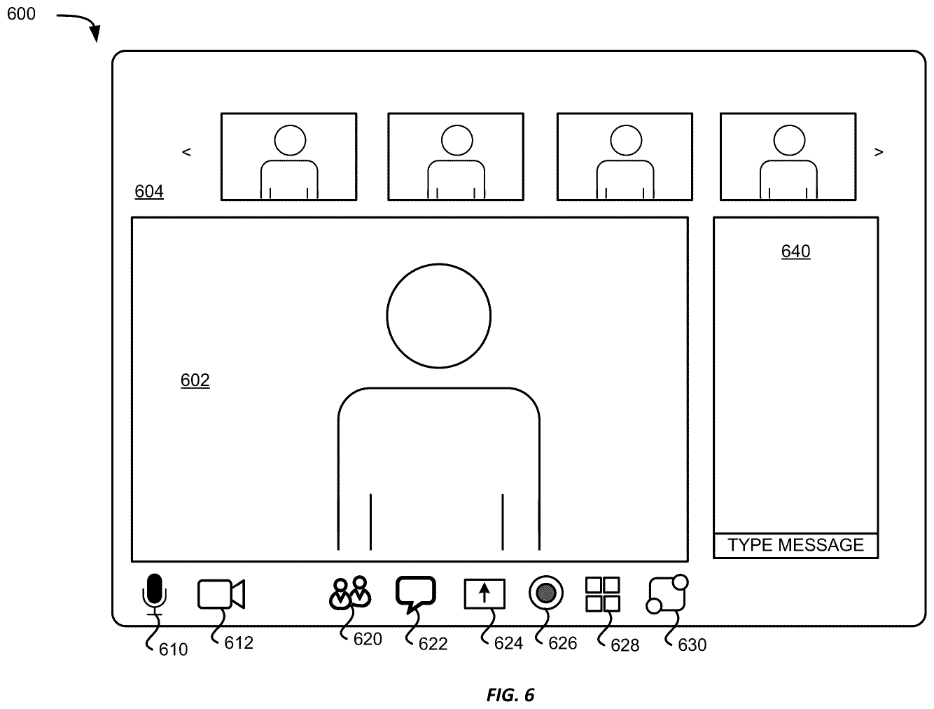

Referring now to FIG. 6, FIG. 6 illustrates an example GUI 600 for a software client that can interact with a system for contextualized spell checking. A client device, e.g., client device 330 or client devices 340a-n, executes a software client as discussed above, which in turn displays the GUI 600 on the client device's display. In this example, the GUI 600 includes a speaker view window 602 that presents the current speaker in the video conference. Above the speaker view window 602 are smaller participant windows 604, which allow the participant to view some of the other participants in the video conference, as well as controls (“<” and “>”) to let the host scroll to view other participants in the video conference. On the right side of the GUI 600 is a chat window 640 within which the participants may exchange chat messages. Text strings input to the chat window 640 can be received as input text strings 450 and the spell-checked text 458 can be displayed in the chat window 640.

Beneath the speaker view window 602 are a number of interactive elements 610-530 to allow the participant to interact with the video conference software. Controls 610-512 may allow the participant to toggle on or off audio or video streams captured by a microphone or camera connected to the client device. Control 620 allows the participant to view any other participants in the video conference with the participant, while control 622 allows the participant to send text messages to other participants, whether to specific participants or to the entire meeting. Control 624 allows the participant to share content from their client device. Control 626 allows the participant toggle recording of the meeting, and control 628 allows the user to select an option to join a breakout room. Control 630 allows a user to launch an app within the video conferencing software, such as to access content to share with other participants in the video conference.

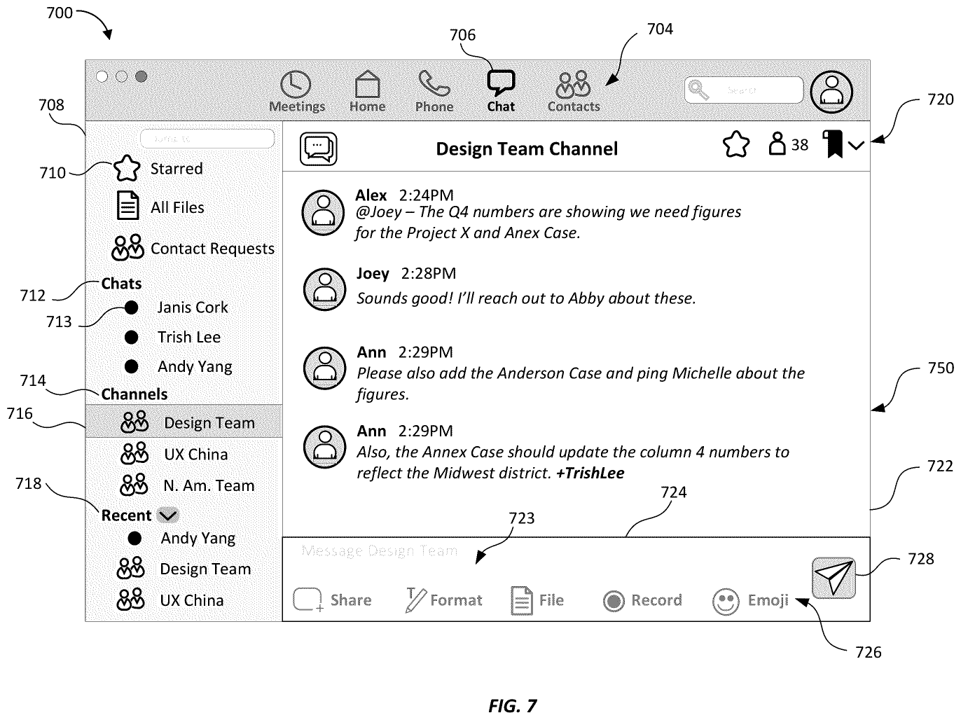

Referring now to FIG. 7, FIG. 7 shows a graphical user interface (“GUI”) for a master chat panel 700 provided as a part of client software executed by a computing device (e.g., client device 330, 340a-n). The chat panel can be used to exchange text-based communication and spell-checking functionality can be provided for this communication. The master chat panel 700 provides access to a variety of chat functionality, including multiple chat channels 714 the user has access to. It also provides a view of an example chat channel 716, according to an embodiment herein. The chat channel 716 may be accessible through the master chat panel 700 by selecting a chat channel from the available chat channels. The master chat panel 700 may be displayed on a client device, such as the client device 220, in response to information sent by a chat and video conference provider, such as the chat and video conference provider 110 in FIG. 1. The master chat panel 700 may be generated by an application, e.g., a standalone chat client or integrated into a video conferencing application, run by one or more processors stored on the client device.

The master chat panel 700 may include a general dashboard 704, a chat control dashboard 720, a sidebar 708, a chat window 750, a reply dashboard 726, and a message composure panel 724. The general dashboard 704 may include one or more buttons or links that switch functionalities and/or views of the master chat panel 700. For example, FIG. 7 shows a chat view, perhaps in response to a user command selecting a chat button 706 in the general dashboard 704. In this view, the chat window 750, the message composure panel 724, and other components illustrated in FIG. 7 may be displayed on the client device. In other examples, a contacts button may be selected by a user. In response the contacts button being selected, the chat window 750, the reply dashboard 726 and the message composure panel 724 may be replaced by a display of a contacts window including a list of user contacts associated with the user of the client device. The sidebar 708 may be displayed alongside the contacts window. Other configurations are also possible. Various buttons on the general dashboard 704 may correspond to various displays of windows being displayed on the client device. Any number of components shown in FIG. 7 may be displayed on the client device with any of the various windows. Similarly, any of the components may cease to be displayed in accordance with any of the windows.

The sidebar 708 may include one or more chat channel headings, such as chats 712, channels 714, and recent 718. Chats 712 heading may include one or more chat channels, such as chat channel 713. The chats 712 may include private chat channels, where messages in a chat channel are exchanged in a one-on-one manner. For example, the chat channel 713 may be between the member viewing the master chat panel 700 and one other member, such as Janis Cork, as depicted. Messages exchanged via the chat channel 713 may only be accessible by the members of the chat channel 713. One-on-one chat channels, such as those provided under the chats 712 heading may allow members to securely communicate with each other or track communications between themselves.

The channels 714 heading may be for chat channels that include two or more users. For example, a chat channel 716 may be included under the channels 714 heading because the chat channel 716 is for a Design Team. The chat channel 716 may include two or more members who have access to send and receive messages within the chat channel 716. In some examples, the chat channel 716 may only be accessed by members who have permission to enter the chat channel 716, such as members who receive and accept an invitation to join the chat channel 716. In some embodiments, a chat channel may have a host or member who has host controls over the chat channel. For example, host controls may include the ability to establish and invite members to a chat channel.

The recent 718 heading may indicate chat channels that a viewing member of the master chat panel 700 has recently viewed. The recent 718 heading may allow the viewing member easy access to commonly or recently viewed or accessed chat channels. “Recently accessed” chat channels may be determined by the client device to be a fixed number of most recent channels accessed by the viewing member or may be only those chat channels access within a certain time, calculated from the current time.

Although only the chat channel headings 712, 714, and 718 are shown, other chat channel headings are possible. For example, some examples may include a chat channel heading that displays, on the client device, only those channels that the user associated with the client device is a member of that have been recently accessed.

The sidebar 708 may also include one or more combinatory headings, such as starred combinatory heading 710. A combinatory heading may aggregate one or more messages from one or more chat channels, according to a predetermined criterion. The combinatory headings may include a link that, in response to a user command, cause the client device to display one or more messages in the chat window 750. The messages may be gathered from one or more chat channels, such as the chat channels 712 or 716, and displayed based on predetermined criteria. In FIG. 7, for example, the starred combinatory heading 710 may gather only those messages that have been marked by a user of the client device. The marked messages may be stored at the client device, and/or may be stored at the chat and video conference provider. The link may cause the one or more processors included on the client device to determine which messages are marked messages and cause them to be displayed in the chat window 750. In some examples, the link may cause the client device to send a signal to the chat and video conference provider. The chat and video conference provider may then determine which messages are marked messages and send information to the client device to generate a display of the marked messages in the chat window 750.

Other combinatory headings (and associated links and functionality) are also considered. Other examples may include an unread heading, an all files heading, a contact request heading, and others. As with the starred combinatory heading 710, an associated link may cause the client device and/or the chat and video conference provider to determine which messages (if any) meet predetermined criteria associated with the combinatory heading and subsequently display those messages on the client device.

As depicted, a viewing participant of the master chat panel 700 may select to access the chat channel 716 for the Design Team. Upon selection of the chat channel 716, the chat window 750 may be provided on the master chat panel 700. The chat window 750 may include the chat control dashboard 720. The chat control dashboard 720 may display one or more control buttons and/or information regarding the chat channel 716 (e.g., the currently viewed chat channel). The control buttons may include links that mark a message (e.g., to mark it such that it is determined to be a marked message via the starred combinatory heading 710), begin a video conference, schedule a meeting, create a video message, or other tasks. The chat control dashboard 720 may also include a title of the chat channel 716 currently being displayed on the client device, such as the “Design Team Channel” as depicted, and/or a number of users with access to the chat channel 716. One of ordinary skill in the art would recognize many different possibilities and configurations.

The chat window 750 may also include a message composure panel 724. The message composure panel 724 may include an input field 723, where the member can input a message and select to send the message to the chat channel 716. The input field 723 may be accessed by a peripheral device such as a mouse, a keyboard, a stylus, or any other suitable input method. In some examples, the input field 723 may be accessed by a touchscreen or other system built into the client device. In some examples, a notification may be sent from the client device and/or the chat and video conference provider that indicates a response is being entered into the input field 723 by the user. In other examples, no notification may be sent.

The reply dashboard 726 may include one or more buttons that, in response to a user command edit or modify a response input into the input field 723. For example, a record button may be provided, that allows the client device to capture audio and video. In other examples, there may be a share button that causes the client device to send the message to a different chat channel. In yet another example, there may be a reaction button that causes an image to be sent by the client device to the chat channel in response to a message posted in the chat channel.

In some examples, there may be one or more formatting buttons included on the reply dashboard 726. The one or more formatting buttons may change the appearance of a reply entered in the input field 723. The user may thereby edit and customize their response in the input field 723 before sending.

The reply dashboard 726 may include a send button 728. The send button 728 may, in response to a user command, cause the client device to send the contents of the input field 723 (or “message”) to the other members of the chat channel 716. The client device may transmit the message to the chat and video conference provider 210, which may in turn transmit the message to the client devices associated with the other members of the chat channel 716. Upon transmission of the message via the send button 728, the message may be published within a chat messaging panel 722. As noted above, messages exchanged within the chat channel 716 may include image files, such as JPEG, PNG, TIFF, or files in any other suitable format, may also include video files such as MPEG, GIF, or video files in any other suitable format, or may also include text entered into the input field 723 and/or other files attached to the message such as a PDF, DOC, or other file format.

As illustrated, the chat window 750 may include the chat messaging panel 722. The chat messaging panel 722 may display messages as they are exchanged between members of the chat channel 716. The messages may be displayed in the chat messaging panel 722 in real-time. The chat messaging panel 722 may include all messages that are exchanged within the chat channel 716 since the generation of the chat channel 716. As could be appreciated, by holding all messages that are exchanged between members of the chat channel 716, the chat messaging panel 722 may include a large volume of messages. Not only could a large volume of messages be generated if the chat channel 716 is active for a long duration of time or includes a large number of members, but also if the members of the chat channel 716 are increasingly communicative.

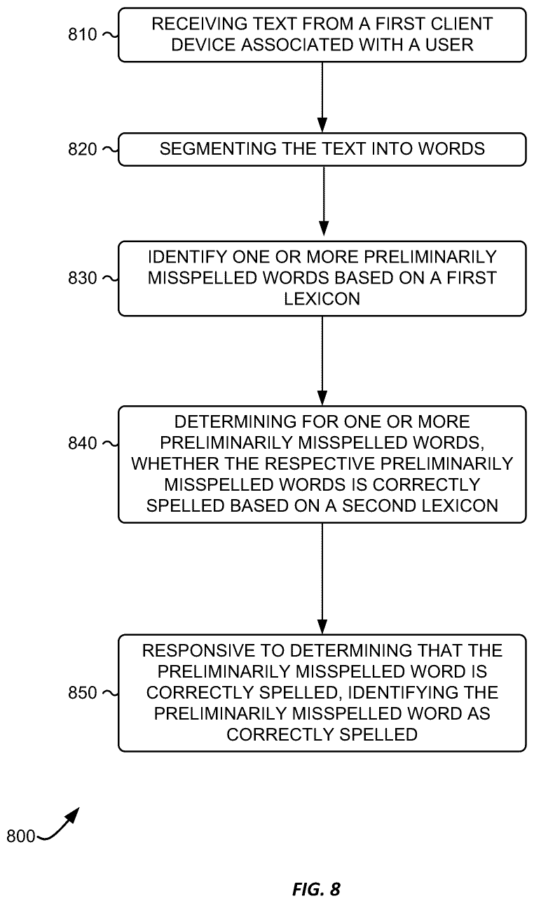

Referring now to FIG. 8, FIG. 8 shows an example method 800 for contextualized spell checking. This example method 800 will be described with respect to the systems 100-400 shown in FIGS. 1-4, the example GUIs 600-700 shown in FIGS. 6-7, and the example machine learning model 500 shown in FIG. 5; however, any suitable systems or GUIs according to this disclosure may be employed.

At block 810, a chat session can receive text from a first client device. The chat session can be part of a chat channel hosted by a video conference provider 210, 310, 410, a video conference hosted by the service, or email messages hosted by the service. The client device can be a client device 140-160, 220-250, 330, 340a-n, associated with a user account and the text can be an input text segment(s) 450. The video conference provider 210, 310, 410 may receive the text by loading a text segment received from a client device 140-160, 220-250, 330, 340a-n, via a network 120, 130, 320, into memory. For example, a user may type a message into a chat window 640 during a video conference, or a user may type a message into a chat channel using input field 723. Receiving the text can include detecting a language for the text (e.g., input text segment(s) 450). The language can be a language associated with the user account, a language associated with a video conference, or a language identified by a language identification process 314, 412. The language detection process 314, 412 may use a trained machine learning model to identify the language (e.g., the predominant language in the received text). The identified language can be used to select one or more of a first lexicon or a second lexicon. The received text can be associated with a user account if the account is logged into software on the client device that generated the input text segment(s) 450.

At block 820, the received text from 810 can be segmented into words by a text segmentation process 316, 414. Segmenting the input text segment(s) into words can mean identifying and labeling words in the identified text segment(s) 452 to generate segmented text 454. The text segmentation process 316, 414 may use a rules-based approach or a trained machine learning model to segment the input text segment.

At block 830, the preliminary spell-checking process 318, 416 can identify one or more preliminarily misspelled words in the 820 based on a first lexicon. The preliminarily misspelled words in the segmented text 454 can be labeled as “misspelled” to generate a preliminarily spell-checked text 456. The preliminarily spell-checked text can be a string with labels identifying each word in the string and a label identifying any preliminarily misspelled words. The preliminary spell-checking process 318, 416 can identify the preliminarily misspelled words by comparing the words from 820 to entries in the first lexicon (e.g., the general lexicon). The preliminary spell-checking process 318, 416 can compare the words from the segmented text 454 against entries in the first lexicon using a rules-based approach (e.g., comparing the characters and order of characters between the words and entries) or using a trained machine learning model. Comparing the words to the first lexicon can include morphological transformations of the words. Identifying a word as preliminarily misspelled can comprise generating metadata, such as a label, for the text.

At block 840, the contextualized spell-checking process 322, 418 can determine whether one or more of the preliminarily misspelled words from 830 is correctly spelled based on a second lexicon. The contextualized spell-checking process can determine any misspelled words by comparing the preliminarily misspelled words against a second lexicon (e.g., the contextual lexicon) to determine if any preliminarily misspelled words match any entries in the lexicon. The second lexicon can be a corpus of words associated with the user account from 810 and the lexicon can be identified from a plurality of lexicons based on a profile associated with the first user from 810, one or more other users related to the first user, a product, a team, a company, a social graph, or a geographic region such as a city/state/region/country. The second lexicon can comprise contextual words such as abbreviations, product names, acronyms, team names, team member names, or jargon terms. The contextualized spell-checking process 322, 418 can compare the words from the preliminarily spell-checked text 454 against entries in the second using a rules-based approach (e.g., comparing the characters and order of characters between the words and entries) or using a trained machine learning model. Comparing the words to the second lexicon can include morphological transformations of the words.

In addition, to detect and alert a user to potentially misspelled named entities, any preliminarily correct words can be checked by a named entity recognition machine learning model in the contextualized spell-checking process 322, 418 to identify words corresponding to named entities. A named entity may include more than one word and a named entity is preliminarily correct if at least one word in the named entity is preliminary correct (e.g., not flagged as preliminarily misspelled at 830). The named entities can be compared against the second lexicon by the contextualized spell-checking process 322, 418 and any preliminarily correct words that match an entry can be labeled as misspelled or potentially misspelled. For instance, “Madeline” may not be labeled as misspelled by the preliminary spell-checking process 318, 416 because the name is in the general lexicon. The named entity recognition model in the contextualized spell-checking process 322, 418 flags “Madeline” as a named entity and compares the name to the contextualized lexicon. In this case, the contextual lexicon includes an entry for a coworker named “Madelyn” and the contextualized spell-checking process 322, 418 flags “Madeline” as a potentially misspelled name.

At block 850, the contextualized spell-checking process 322, 418 can identify the preliminarily misspelled word as correctly spelled. The correctly spelled word can be identified in response to a determination that the preliminarily misspelled word is correctly spelled. For example, the preliminarily misspelled labels can be removed from words in the preliminarily spell-checked text 456 that match entries in the contextual lexicon, and any preliminarily misspelled labels can be maintained on words that do not match any entries in the contextual lexicon. This preliminarily spell-checked text, with labels that are altered by the contextualized spell-checking process 418, can be output as spell-checked text 458. The output spell-checked text 458 can be provided to the client computing device from 810 and the spell-checked text can be used to generate a graphical display and displayed on a display device (e.g., as part of a graphical user interface). Identifying a preliminarily misspelled word as correctly spelled can comprise deleting metadata, such as a label, that is associated with the text.

The description of the example method 800 provides a particular ordering of functionality for purposes of illustration. However, it should be appreciated that virtual spaces are dynamic and operate asynchronously. Thus, as members interact with the video conference provider 210, 310 or 410 to request transcription services, translation services, or language identification, the state of the video conference provider changes based on those interactions. And since the interactions may be driven by user selections or occur in response to user inputs, they may occur in any suitable ordering or any number of times. Thus, the method 800 illustrates functionality available within the space according to one example sequence of interactions with the video conference provider 210, 310 or 410. In some examples, various steps may be performed in different orders or may be omitted.

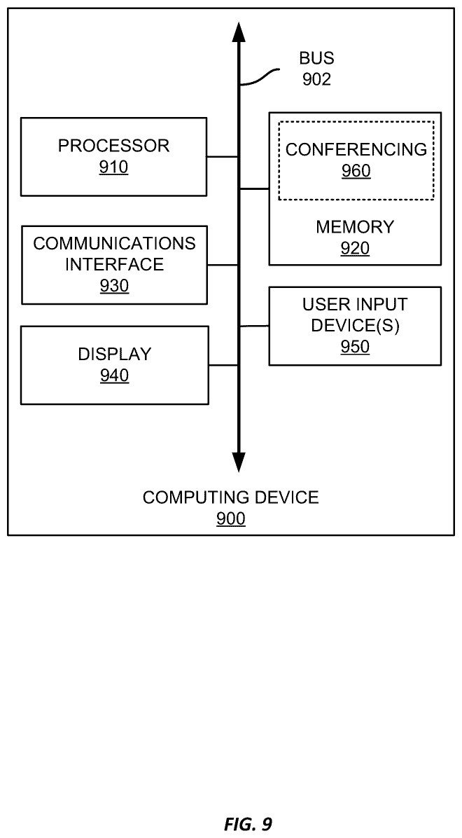

Referring now to FIG. 9, FIG. 9 shows an example computing device 900 suitable for use in example systems or methods for contextualized spell-checking according to this disclosure. The example computing device 900 includes a processor 910 which is in communication with the memory 920 and other components of the computing device 900 using one or more communications buses 902. The processor 910 is configured to execute processor-executable instructions stored in the memory 920 to perform one or more methods for contextualized spell-checking according to different examples, such as part or all of the example methods 800, 900 described above with respect to FIGS. 8 and 9. The computing device 900, in this example, also includes one or more user input devices 950, such as a keyboard, mouse, touchscreen, microphone, etc., to accept user input. The computing device 900 also includes a display 940 to provide visual output to a user.

In addition, the computing device 900 includes a video conferencing application 960 to enable a user to join and participate in one or more virtual spaces or in one or more conferences, such as a conventional conference or webinar, by receiving multimedia streams from a video conference provider, sending multimedia streams to the video conference provider, joining and leaving breakout rooms, creating video conference expos, etc., such as described throughout this disclosure, etc.

The computing device 900 also includes a communications interface 940. In some examples, the communications interface 930 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random-access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

What is claimed is:

1. A method, comprising:
receiving, from a chat session by a video conference provider, text from a first client device, the first client device associated with a first user;
segmenting the text into one or more words;
identifying one or more preliminarily misspelled words based on a first lexicon;
determining, for at least one of the one or more preliminarily misspelled words, whether the respective preliminarily misspelled word is correctly spelled based on a second lexicon; and
responsive to determining the preliminarily misspelled word is correctly spelled, identifying the preliminarily misspelled word as correctly spelled.

2. The method of claim 1, further comprising identifying the second lexicon from a plurality of lexicons based on a profile associated with the first user, one or more other users related to the first user, a product, a team, a company, a social graph, or a geographic region.

3. The method of claim 2, wherein the second lexicon comprises one or more abbreviations, product names, acronyms, team names, team member names, or jargon terms.

4. The method of claim 1, wherein:
identifying the one or more preliminarily misspelled words comprises generating metadata associated with the text; and
identifying the preliminarily misspelled word as correctly spelled comprises deleting metadata associated with the preliminarily misspelled word.

5. The method of claim 1, further comprising:
identifying one or more preliminarily correctly spelled words;
determining, for at least one of the one or more preliminarily correctly spelled words, whether the respective preliminarily correctly spelled word is incorrectly spelled based on the second lexicon; and
responsive to determining the preliminarily correctly spelled word is misspelled, identifying the preliminarily correctly spelled word as misspelled.

6. The method of claim 1, further comprising:
determining a language associated with the text; and
selecting the first and second lexicons based on the language.

7. The method of claim 1, wherein the chat session is associated with a video conference hosted by the video conference provider.

8. The method of claim 1, wherein the chat session is provided by a chat channel hosted by the video conference provider.

9. A non-transitory computer readable medium storing a set of instructions, the set of instructions comprising:
receiving, from a chat session by a video conference provider, text from a first client device, the first client device associated with a first user;
segmenting the text into one or more words;
identifying one or more preliminarily misspelled words based on a first lexicon;
determining, for at least one of the one or more preliminarily misspelled words, whether the respective preliminarily misspelled word is correctly spelled based on a second lexicon; and
responsive to determining the preliminarily misspelled word is correctly spelled, identifying the preliminarily misspelled word as correctly spelled.

10. The non-transitory computer readable medium of claim 9, further comprising identifying the second lexicon from a plurality of lexicons based on a profile associated with the first user, one or more other users related to the first user, a product, a team, a company, a social graph, or a geographic region.

11. The non-transitory computer readable medium of claim 10, wherein the second lexicon comprises one or more abbreviations, product names, acronyms, team names, team member names, or jargon terms.

12. The non-transitory computer readable medium of claim 9, wherein:
identifying the one or more preliminarily misspelled words comprises generating metadata associated with the text; and
identifying the preliminarily misspelled word as correctly spelled comprises deleting metadata associated with the preliminarily misspelled word.

13. The non-transitory computer readable medium of claim 9, further comprising:
identifying one or more preliminarily correctly spelled words;
determining, for at least one of the one or more preliminarily correctly spelled words, whether the respective preliminarily correctly spelled word is incorrectly spelled based on the second lexicon; and
responsive to determining the preliminarily correctly spelled word is misspelled, identifying the preliminarily correctly spelled word as misspelled.

14. The non-transitory computer readable medium of claim 9, further comprising:
determining a language associated with the text; and
selecting the first and second lexicons based on the language.

15. The non-transitory computer readable medium of claim 9, wherein the chat session is associated with a video conference hosted by the video conference provider.

16. The non-transitory computer readable medium of claim 9, wherein the chat session is provided by a chat channel hosted by the video conference provider.

17. A computing device, comprising:
one or more memories; and
one or more processors, communicatively coupled to the one or more memories, configured to perform operations comprising:
receiving, from a chat session by a video conference provider, text from a first client device, the first client device associated with a first user;
segmenting the text into one or more words;
identifying one or more preliminarily misspelled words based on a first lexicon;
determining, for at least one of the one or more preliminarily misspelled words, whether the respective preliminarily misspelled word is correctly spelled based on a second lexicon; and
responsive to determining the preliminarily misspelled word is correctly spelled, identifying the preliminarily misspelled word as correctly spelled.

18. The computing device of claim 17, further comprising identifying the second lexicon from a plurality of lexicons based on a profile associated with the first user, one or more other users related to the first user, a product, a team, a company, a social graph, or a geographic region.

19. The computing device of claim 18, wherein the second lexicon comprises one or more abbreviations, product names, acronyms, team names, team member names, or jargon terms.

20. The computing device of claim 17, wherein:
identifying the one or more preliminarily misspelled words comprises generating metadata associated with the text; and
identifying the preliminarily misspelled word as correctly spelled comprises deleting metadata associated with the preliminarily misspelled word.
